(19) United States
(12) Patent Application Publication
(10) Pub. No.: US 2016/0025324 A1
(43) Pub. Date: Jan. 28, 2016

(54) WATERPROOF LED LUMINAIRE

(71) Applicants: Chih Chiang HSU, Taipei City (TW); Morishita Taiwan Co., LTD., Taipei City (TW)

(72) Inventors: Chou Jung HUANG, Taipei City (TW); Chih Chiang HSU, Taipei City (TW)

(21) Appl. No.: 14/337,746

(22) Filed: Jul. 22, 2014

(51) Int. Cl. F21V 31/00; F21V 23/02; F21V 15/015

(52) U.S. Cl. CPC F21V 31/00; F21V 15/015; F21V 23/02; F21Y 2103/003

(57) ABSTRACT

A waterproof LED luminaire is provided, which mainly comprises a lamp holder, a light emitting diode module, a cover plate, a first side cover and a second side cover. Each of the first side cover and the second side cover has a waterproof groove provided on its inner wall surface. When both side covers are respectively assembled on both sides of the lamp holder, both the side edges of both sides of the lamp holder are fitted respectively with the waterproof grooves in such a manner that liquid can be prevented from infiltrating into the interior of the lamp holder. Therefore, the overall waterproof performance of the present invention can be enhanced.

### FIELD OF THE INVENTION

The present invention relates to a waterproof LED luminaire used in outdoor or humid environment, more particularly to a waterproof LED luminaire which can avoid infiltration of liquid into interior of the lamp holder effectively.

### BRIEF DESCRIPTION OF THE PRIOR ART

There are many different kinds of luminaire available on the market. FIG. 1 is a schematic view (I) of a conventional luminaire assembly. As shown in the figure, the luminaire 10 comprises a lamp holder 101; a light emitting diode module 102 provided within the lamp holder 101; a cover plate 103 provided above the lamp holder 101; and two side covers 104 respectively assembled on both sides of the lamp holder 101. Further referring to FIG. 2 showing a schematic view (II) of a conventional luminaire assembly, when the two side covers 104 are respectively assembled on both sides of the lamp holder 101, tight combination states is not reached between the two side covers 104 and the side edges of the lamp holder 101. When the luminaire 10 is installed in outdoor or humid environment, liquid is able to infiltrate easily into the interior of the lamp holder 101 through the crack between the side covers 104 and the lamp holder 101 (as shown by the arrow direction in the figure), to cause short circuit and damage of electronic components inside the lamp holder 104. According to a Taiwanese Utility Model Patent Gazette No. M348890 entitled “Outdoor LED Luminaire” and a Taiwanese Utility Model Patent Gazette No. M467806 entitled “Outcasing Structure of Luminaire”, the techniques disclosed in these documents mainly conduct waterproof function either by employing waterproof edge stripes or by fixing members for integral assembly of the overall luminaire. However, once using for a long time, the waterproof edge stripes and the fixing members will become loose or suffer elastic fatigue, and the performance of waterproof is unable to be maintained anymore.

### SUMMARY OF THE INVENTION

In view of the above problems, the main object of the present invention is to provide a waterproof LED luminaire without liquid infiltration into the interior of LED luminaire.

In order to achieve above object, the waterproof LED luminaire of the present invention mainly comprises a lamp holder, a light emitting diode module provided within the lamp holder, a cover plate provided above the lamp holder, a first side cover and a second cover respectively assembled on both sides of lamp holder. Further, the light emitting diode module is electrically connected with the first side cover so that an external power source after electrical connection to the first side cover can provide sufficient power for the light emitting diode module. Moreover, each of the first side cover and the second side cover has a waterproof groove formed in their interiors. When the side covers are assembled on both sides of the lamp holder, the waterproof grooves can form tight sealing with both side edges so that infiltration of liquid through the crack between the side covers and the side edges of the lamp holder into the interior of the lamp holder can be effectively avoided.

### BRIEF DESCRIPTION OF THE DRAWINGS

FIG. 1 is a schematic view (I) showing a conventional luminaire.

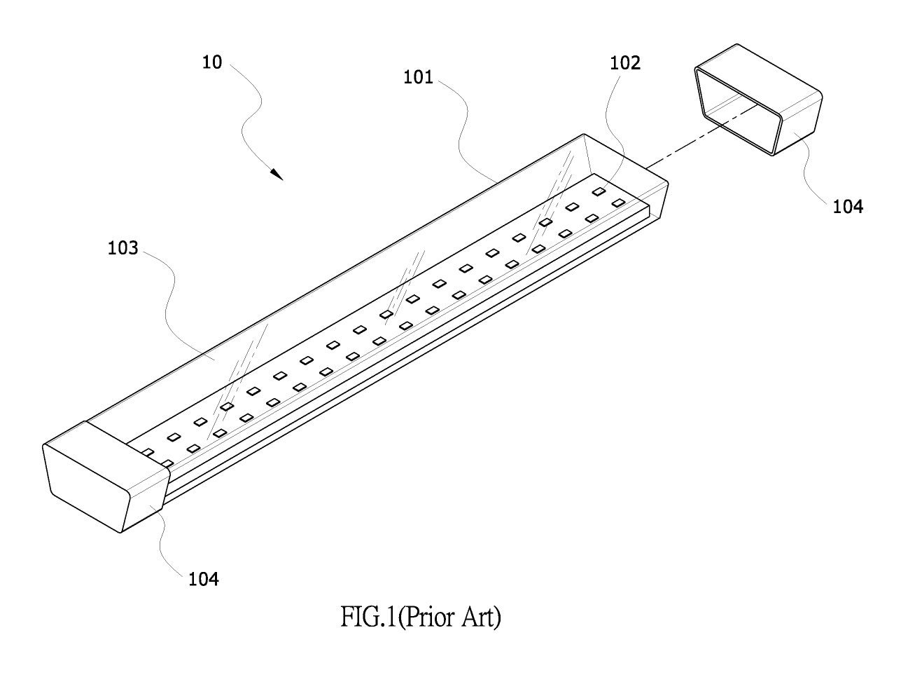

FIG. 2 is a schematic view (II) showing a conventional luminaire.

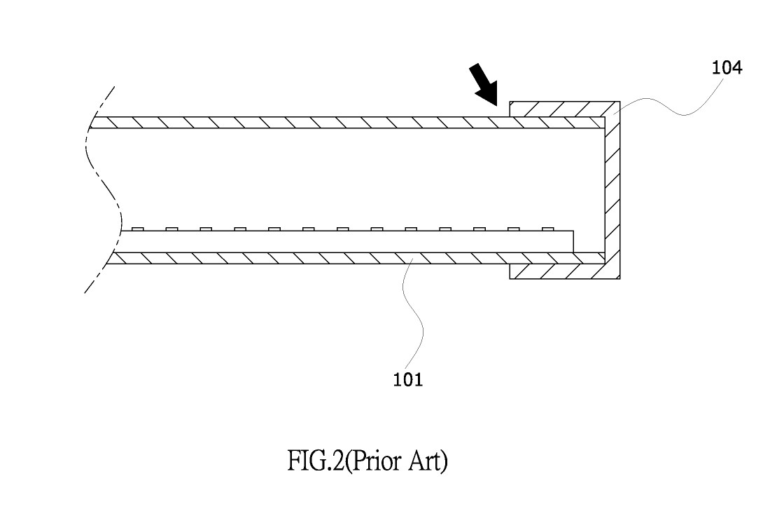

FIG. 3 is a schematic view showing the structural constitution of the present invention.

FIG. 4 is a schematic view showing the constituent elements of the present invention.

FIG. 5 is a schematic view showing the implementation of the present invention.

FIG. 6 is another embodiment (I) of the present invention.

FIG. 7 is still another embodiment (II) of the present invention.

### DETAILED DESCRIPTION OF PREFERRED EMBODIMENTS

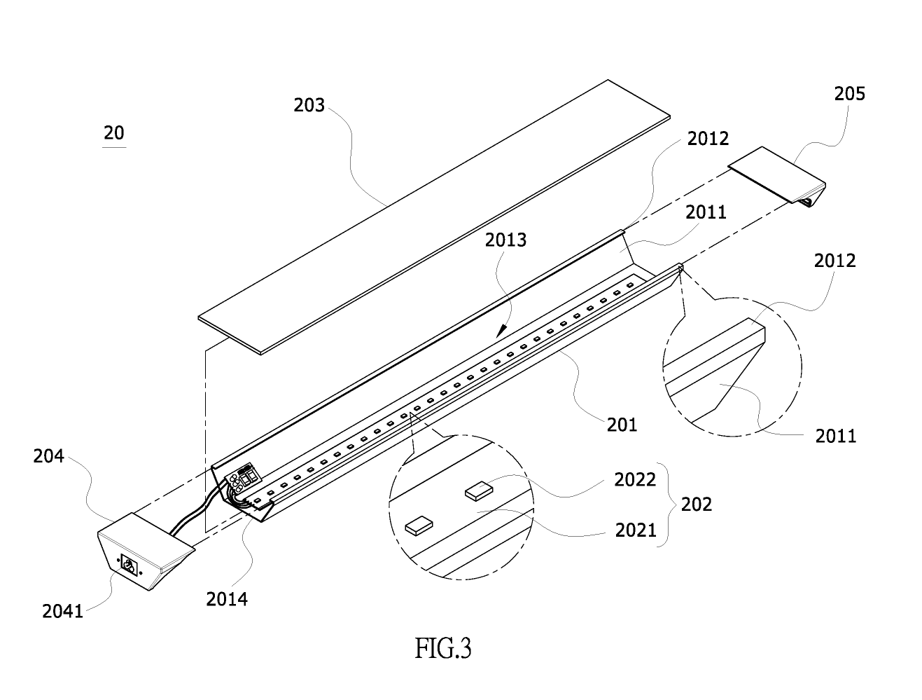

FIG. 3 is a schematic view showing the structural constitution of the present invention. The waterproof LED luminaire 20 as shown in the FIG. 3 is mainly formed by a lamp holder 201, a light emitting diode module 202, a lamp cover 203, a first side cover 204 and a second side cover 205. The lamp holder 201 has slant side walls 2011 bending inward and provided at both sides thereof, and the end of each slant side wall 2011 has a stop section 2012 bending inward. In this manner, an open type accommodation space 2013 is formed in the interior of the lamp holder 201. The light emitting diode module 202 has a substrate 2021 and a plurality of light emitting diodes 2022 which are electrically connected and fixed respectively on the surface of the substrate 2021. The light emitting diode module 202 is received in the accommodation space 2013 of the lamp holder 201, and the surface of the light emitting diode module 202 is coated with a hydrophobic agent after packaging, such that each of the light emitting diodes 2022 is overlaid with a hydrophobic layer. In this manner, the waterproof performance of the overall light emitting diode module 202 can be enhanced. The lamp cover 203 is transparent in such a manner that the light emitted from the light emitting diode module 202 can transmit through the lamp cover 203. The lamp cover 203 is assembled in the accommodation space 2013 of the lamp holder 201 in such a manner that two sides of the lamp cover 203 in normal state abut respectively against both slant side walls 2011 and are limited by the stop sections 2012. Thus, the lamp cover 203 can overlay above the accommodation space 2013. A first side cover 204 and a second side cover 205 are respectively provided on both side edges 2014 of the lamp holder 201 such that the accommodation space 2013 of the lamp holder 201 forms an enclosure. The first side cover 204 is provided with a power supply section 2041 which is electrically connected with the substrate 2011 of the light emitting diode module 202. By the connection of the power supply section 2041 to an external power source, power can be supplied to drive the light emitting diode module 202. Further, in order to avoid such problems as short circuit failure caused by water leakage to the electrical components of the present invention, the electrical connection part of each of the electrical components, such as power supply section 2041, circuit control board, is packaged with a thermal conductive epoxy resin to upgrade its overall waterproof performance so as to prevent short circuit failure from happening.

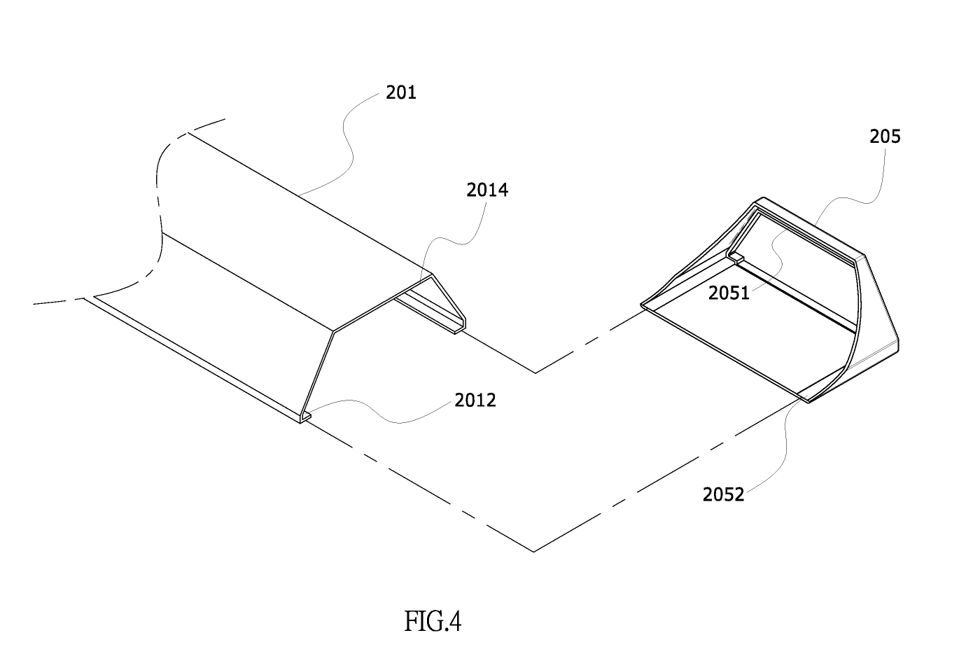

FIG. 4 is a schematic view showing the constituent elements of the present invention. As shown in the FIG. 4, the second side cover 205 has the same structure as that of the first side cover 204, therefore only the structure of the first side cover 204 is exemplified in this disclosure. Referring to the first side cover 204 or the second side cover 205 in this figure, there is a waterproof groove 2051 formed in its interior. The waterproof groove 2051 is formed in the inner wall face of the second side cover 205 and the width of the waterproof groove 2051 is approximately equal to the thickness of the side edge 2014 of the lamp holder 201. Two guide sections 2052 are respectively provided on both sides of the bottom of the second side cover 205 to serve as the guiding entry for the stop sections 2012 of the lamp holder 201, when the second side cover 205 is assembled on the side edge 2014 of the lamp holder 201, so that the side edge 2014 of the lamp holder 201 can conveniently fitted into the waterproof groove 2051.

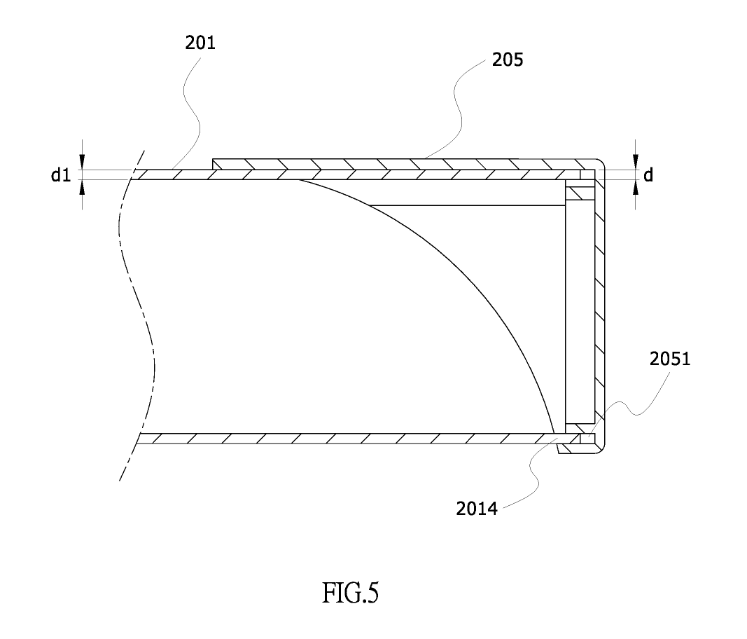

FIG. 5 is a schematic view showing the implementation of the present invention. As the width d of the waterproof groove 2051 of the second side cover 205 is approximately equal to the thickness of the side edge 2014 of the lamp holder 201, the side edge 2014 of the lamp holder 201 can form tight sealing with the waterproof groove 2051 after the side edge 2014 is fitted into the waterproof groove 2051, so as to prevent the second side cover 205 from separating with the side edge of the lamp holder 201. In this manner, when liquid is infiltrated from the side edge 2014 of the lamp holder 201, it is blocked by the waterproof groove 2051 so as not to enter into the interior of the lamp holder 201 to damage the electronic components.

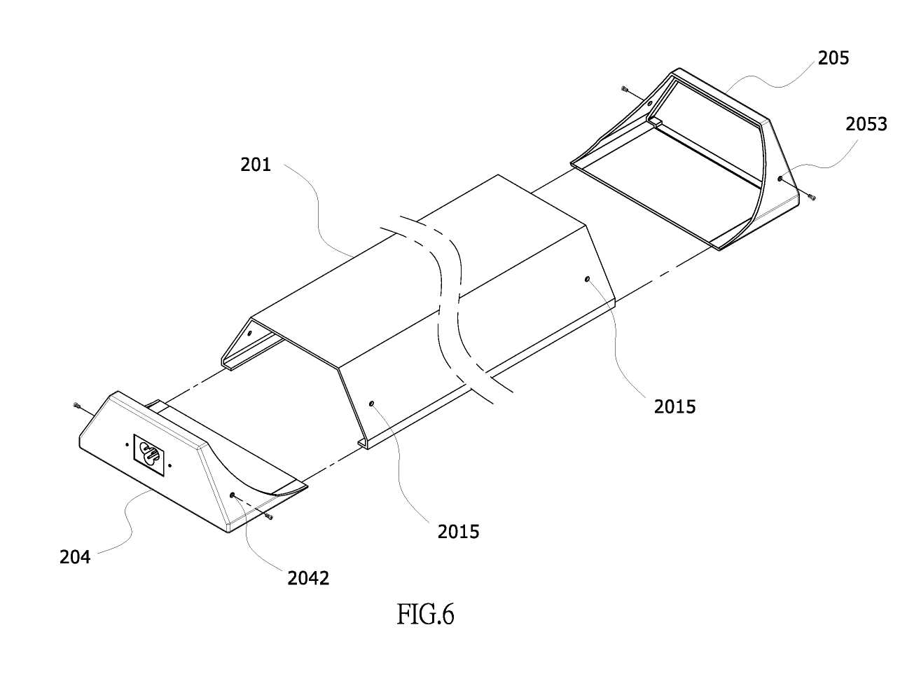

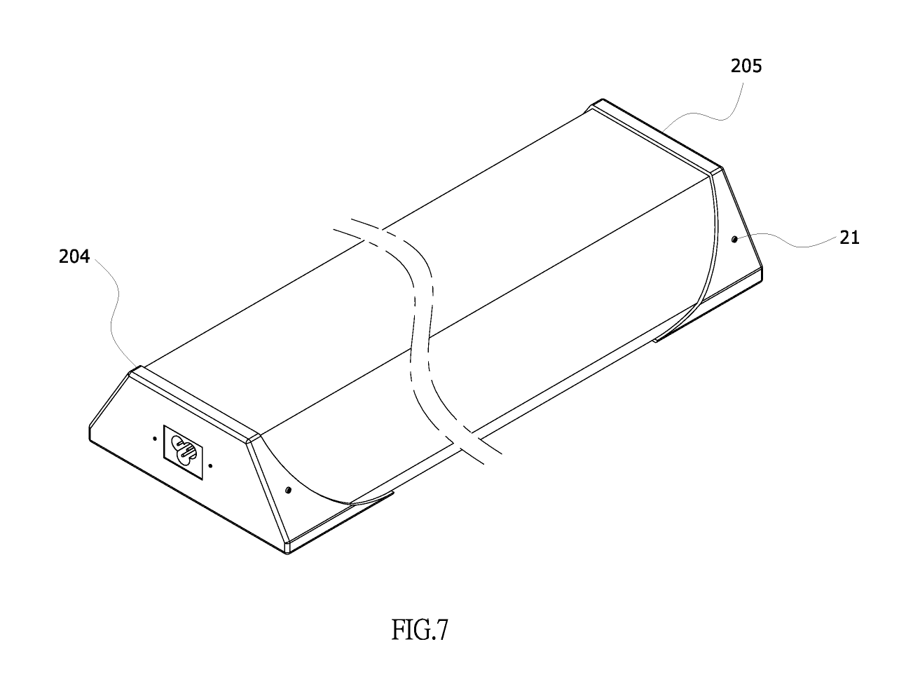

FIG. 6 is another embodiment (I) of the present invention and referring to FIG. 3 simultaneously, in order that the first side cover 204 and the second side cover 205 can combine more firmly with the lamp holder 201, several through holes 2015 are provided respectively on both side walls of the lamp holder 201, and holes (2042, 2053) corresponding to the through holes 2015 are also provided respectively on the first side cover 204 and the second side cover 205. Further referring to FIG. 7, when the first side cover 204 and the second side cover 205 are respectively assembled to both sides of the lamp holder 201, fixing members 21 passing through the through holes 2015 and the corresponding holes (2042, 2053) are used to fix the first side cover 204 and the second side cover 205 firmly on both sides of the lamp holder 201, so as to prevent the first side covers 204 and the second side cover 205 from loosening more effectively.

Summing up above, the waterproof LED luminaire of the present invention mainly provides waterproof grooves, respectively formed on the first side cover and the second side cover, for fitting with the side edges of the lamp holder to form tight sealing, so that liquid infiltrated through the first side cover and the second side cover is blocked by the waterproof grooves. Implementing in this manner, the present invention is able to provide a waterproof LED luminaire which can surely prevent liquid from infiltration into the interior of the luminaire.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

1. A waterproof LED luminaire, which can be used in outdoor environment, comprising:
a lamp holder having slant side walls bending inward and provided respectively at both sides thereof, the end of each said slant side walls having a stop section bending inward; thus, an open type accommodation space being formed in the interior of said lamp holder by the formation of said two slant side walls;
a light emitting diode module provided within said accommodation space, said light emitting diode module having a substrate and a plurality of light emitting diodes which are electrically connected and fixed respectively on the surface of said substrate; the surface of each of said light emitting diodes being coated with a hydrophobic layer;
a lamp cover which is transparent having its two sides abutted against said side walls respectively and limited by said stop sections in such a manner that said lamp cover is constrained within said accommodation space; and
a first side cover and a second side cover, each having a waterproof groove formed on the inner wall surface thereof for fitting by side edges respectively formed on both sides of said lamp holder; said first side cover having a power supply section provided to connect electrically with said substrate of said light emitting diode module; by the connection of said power supply section to an external power source, power is supplied to drive said light emitting diode module.

2. The waterproof LED luminaire as claimed in claim 1, wherein each of said first side cover and said second side cover has guide sections formed respectively on both sides of the bottom thereof to serve as the guiding entry for said stop sections of the lamp holder when said first side cover and said second side cover are assembled on the side edges of the lamp holder, so that the side edges of said lamp holder are conveniently fitted into said waterproof grooves.

3. The waterproof LED luminaire as claimed in claim 1, wherein several through holes are provided respectively on both side walls of said lamp holder, and the corresponding holes corresponding to said through holes are also provided respectively on said first side cover and said second side cover; fixing members respectively passing through said through holes and said corresponding holes are used to fix said first side cover and said second side cover firmly on both sides of said lamp holder.

4. The waterproof LED luminaire as claimed in claim 1, wherein the electrical connections parts of said power supply section and said circuit control board are packaged with thermal conductive epoxy resin.
